(19) United States
(12) Patent Application Publication
(10) Pub. No.: US 2011/0145807 A1
(43) Pub. Date: Jun. 16, 2011

(54) METHOD AND DEVICE FOR UPDATING A COMPUTER APPLICATION

(75) Inventors: Alain Molinie, Montpellier (FR); Eric Lavigne, Montpellier (FR); Vincent Leclaire, Montpellier (FR)

(73) Assignee: AWOX, Montpellier (FR)

(21) Appl. No.: 12/995,746

(22) PCT Filed: Jun. 2, 2009
(86) PCT No.: PCT/FR2009/000637

§ 371 Date: Feb. 24, 2011

(30) Foreign Application Priority Data
Jun. 2, 2008 (FR) 0803034

(51) Int. Cl. G06F 9/44

(52) U.S. Cl. 717/170

(57) ABSTRACT

A method for updating computer applications includes: creating partitions for software programs in a non-volatile memory; writing, in a first partition, an initial version of a software program, bootloader environment variables of the initial version of the software program, and at least one sub-portion of the operating system kernel; and during the updating of the software program, writing in a second partition, different from the first partition, a new version of the software program different from the current version, bootloader environment variables of the new version of the software program, and at least one sub-portion of the operating system kernel. Preferably, the method includes: determining whether the new version of the software program is in operation and, if so, assigning to the new version an indicator that it is active, and assigning to the previous version an indicator that it is inactive, the indicators being stored in a software partition map partition.

This invention concerns a method and a device for updating computer applications. It applies in particular to the updating of programs in embedded applications.

Most embedded devices now support updating of their proprietary software program. However, the update procedure is usually:
dangerous, notably if the electrical power supply is cut, with the device possibly becoming unusable;
irreversible, i.e. users cannot roll back to the old software program if they are not satisfied with the new software program, and
not secure, i.e. users or hackers can install a software program that the supplier of the device has not necessarily approved or certified for use on the device.

The latest embedded devices run under advanced operating systems such as Linux (registered trademark) or Windows CE (registered trademark) and have a complex booting process that comprises multiple stages. Typically, this boot involves several levels:

1) the bootloader and boot parameters, possibly including a startup logo;

2) the operating system kernel and its root file system and

3) the application and application parameters.

Globally, levels 2 and 3 are referred to as “software program” below. Each of these levels uses different procedures and tools and itself possibly contains several sub-levels, particularly in the case of the bootloader. Because of this complexity, many devices only support the updating of a subset of these levels, usually the latter, or alternatively use a very primitive form of updating that directly replaces the entire contents of the non-volatile memory.

This technique creates additional potential problems with certain types of non-volatile memory (e.g. NAND flash, increasingly used for economic reasons), which may present the problem of lost blocks that either exist from the outset or appear at runtime, especially during rewriting.

In addition, digital rights management (“DRM”) mechanisms embedded in the devices utilizing digital media require strong security mechanisms, such as the encoding, electronic signature and “re-authoring” (re-encryption, or re-encoding, designed to uniquely link a software program to an item of hardware) of software programs integrating these mechanisms. Significant constraints are associated with these protective measures and their implementation is therefore critical.

This is usually not or poorly supported by existing devices for updating embedded software programs and/or conflicts with the need for an update that is both flexible and simple for the user.

The aim of this invention is to remedy these disadvantages.

To this end, according to a first aspect, the present invention envisages a method of updating computer applications, characterized in that it comprises:
a step of creating partitions for software programs in a non-volatile memory,
a step of writing, in a first partition, an initial version of a software program, bootloader environment variables of said initial version of the software program, and at least one sub-portion of the operating system kernel and
during the updating of said software program, a step of writing in a second partition, different from the first partition, a new version of the software program different from the current version, bootloader environment variables of said new version of the software program, and at least one sub-portion of the operating system kernel.

Thanks to these provisions, booting the new version is easy and, if the update is not successful or if the user so chooses, the old version can be used again without having to reload said former version of the software program from an external source since it is in the first partition. Thus, at any time, a software program in one partition is in operation while other partitions contain old proprietary software programs, are reusable or have free space that can be used for new software programs or new versions of a software program that is already present. When a user decides to update the system, a new software program is written in an empty or reusable partition and the system in operation is left intact for a possible roll-back to the previous version. In effect, if the user does not wish to continue using the updated system, for whatever reason, he or she can choose to switch back to the previously active proprietary software program or to any other proprietary software program stored in the system. It is also noted that the bootloader's environment variables are stored in the software partition and not in a bootloader partition, so that this bootloader partition does not need to be changed during a proprietary software program update.

According to particular features, during the partition creation step, a map of partition assignments is also created listing the versions and status of the software program present and indicating which version of the software program is active.

According to particular features, in at least one step of writing to a partition, a version of the software program including a kernel and root file system is written in addition to bootloader environment variables.

According to particular features, the method that is the subject of the present invention, as described in brief above, comprises a step of determining whether the new version of the software program is in operation and, if so, a step of assigning to the new version an indicator that it is active, and assigning to the previous version an indicator that it is inactive.

According to particular features, said indicators are stored in a software partition map.

Thus, it is only after the software update is successfully completed that the software partition map is updated so that the new software program becomes active and runs instead of the old. In addition, this partition schematic is such that, at most, only the software partition map and one of the proprietary software partitions are changed during the updating of a software program.

According to particular features, at least one part of the software partition map is stored outside the non-volatile memory storing the proprietary software program, e.g. in a separate non-volatile memory.

This mode of operation is known as “static” and is more secure than the mode of operation known as “dynamic”, in which the partition map is changed during an update and is stored in the same memory as the different versions of the proprietary software program.

According to special characteristics, during the updating of the software program it is determined for each sub-portion of the update software program whether this sub-portion must be copied from the previous version of said software program and, if so, the corresponding sub-portion is copied from the old version's partition to the new version's partition.

Thanks to these provisions, sub-portions of the software program, notably user settings, can be preserved from one version of the software program to the next. The update and partition schematic thus supports the retention of all or part of the user settings and/or other partitions of interest between the updates without compromising the ability to roll back since said parameters were copied before modification and are thus preserved for the previous version.

According to particular features, during the update, a large-enough free or reusable area is sought in the partitions and, if at least one is found, the step of writing the new version of the software program different from the current version, bootloader environment variables of said new version of the software program, and at least one kernel image and one root file system image is performed in a free or reusable area.

According to particular features, if a large-enough free or reusable area is not found, a step is performed of requesting the user to choose whether to accept not being able to roll back to the current version of the software program after the update and if the user agrees, in an area covering the first partition, the step is performed of writing the new version of the software program different from the current version, bootloader environment variables of said new version of the software program, and at least one kernel image and one root file system image.

According to a second aspect, the present invention envisages a device for updating computer applications, characterized in that it comprises:
a means of creating partitions for software programs in a non-volatile memory and
a means of writing designed to write, in a first partition, an initial version of a software program, bootloader environment variables of said initial version of the software program, and at least one operating system kernel image and, during the updating of said software program, to write in a second partition, different from the first partition, a new version of the software program different from the current version, bootloader environment variables of said new version of the software program, and at least one operating system kernel image.

According to a third aspect, the present invention envisages a computer program that can be loaded into a computer system, said program containing instructions enabling the method that is the subject of the present invention, as described in brief above, to be utilized.

According to a fourth aspect, the present invention envisages a data carrier that can be read by a computer or microprocessor, removable or not, holding the instructions of a computer program, characterized in that it allows the method that is the subject of the present invention, as described in brief above, to be utilized.

As the particular characteristics, advantages and aims of this device, this program and this data carrier are similar to those of the method of updating that is the subject of the present invention, as described in brief above, they are not repeated here.

Other advantages, aims and characteristics of the present invention will become apparent from the description that will follow, made, as an example that is in no way limiting, with reference to the drawings included in an appendix, in which:

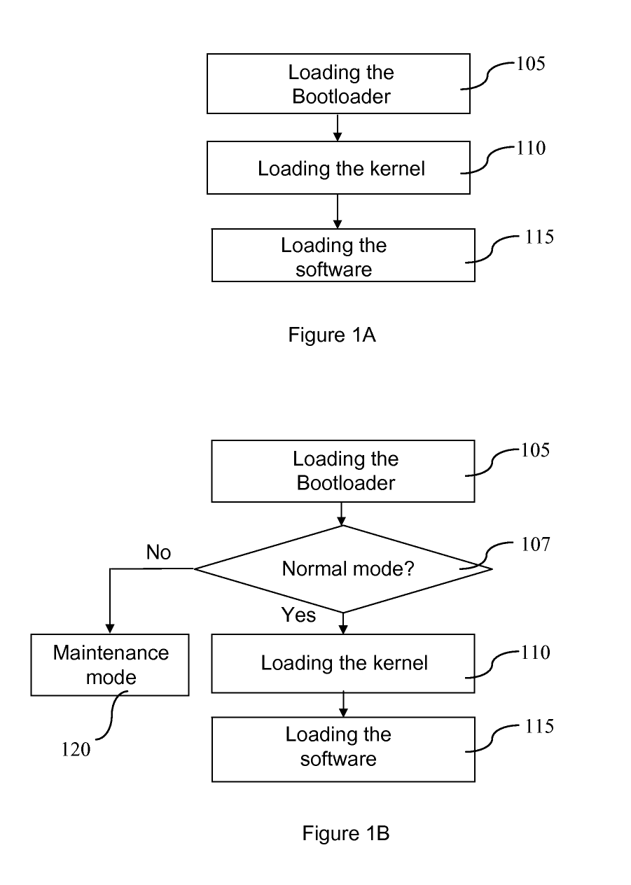

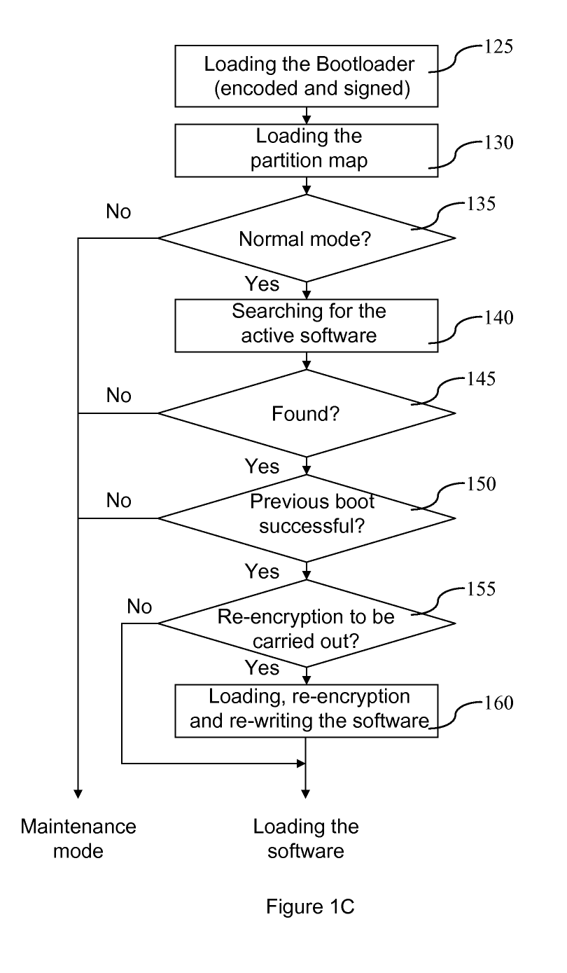

FIG. 1A shows, in the form of a logical diagram, steps utilized during a normal boot of a standard embedded system, according to the state of the art, without a recovery or maintenance procedure,

FIG. 1B shows, in the form of a logical diagram, steps utilized during a boot of an embedded system according to the state of the art supporting a simple maintenance mode,

FIG. 10 shows, in the form of a logical diagram, steps utilized during a boot in a particular embodiment of the method that is the subject of the present invention,

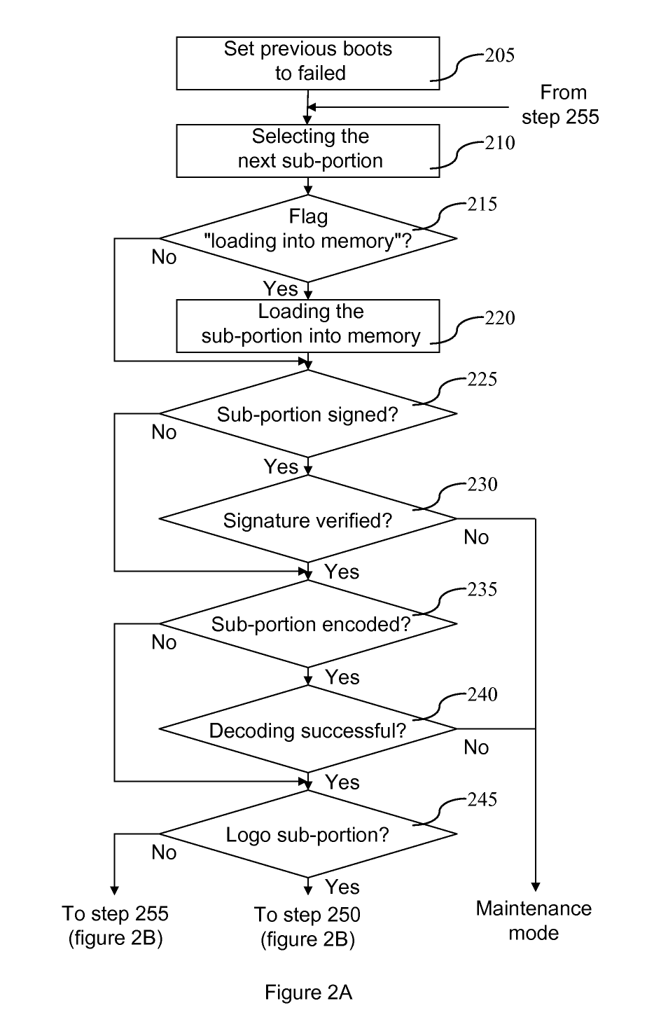

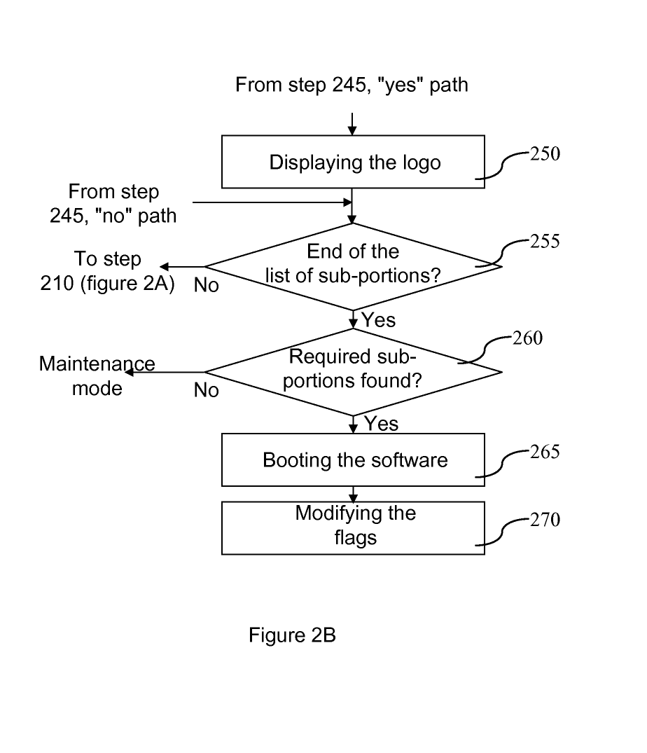

FIGS. 2A and 2B show, in the form of logical diagrams, sub-steps utilized during a software load in a particular embodiment of the method that is the subject of the present invention,

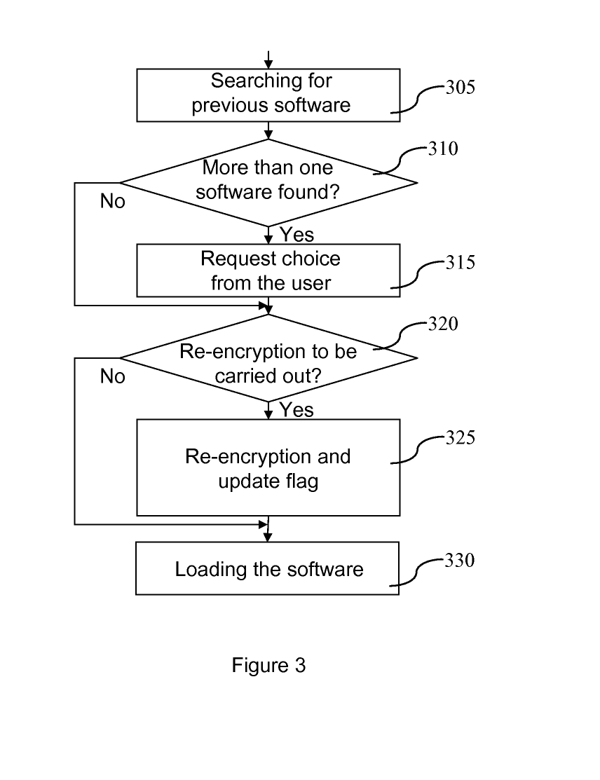

FIG. 3 shows, in the form of a logical diagram, steps utilized in a maintenance mode in a particular embodiment of the method that is the subject of the present invention,

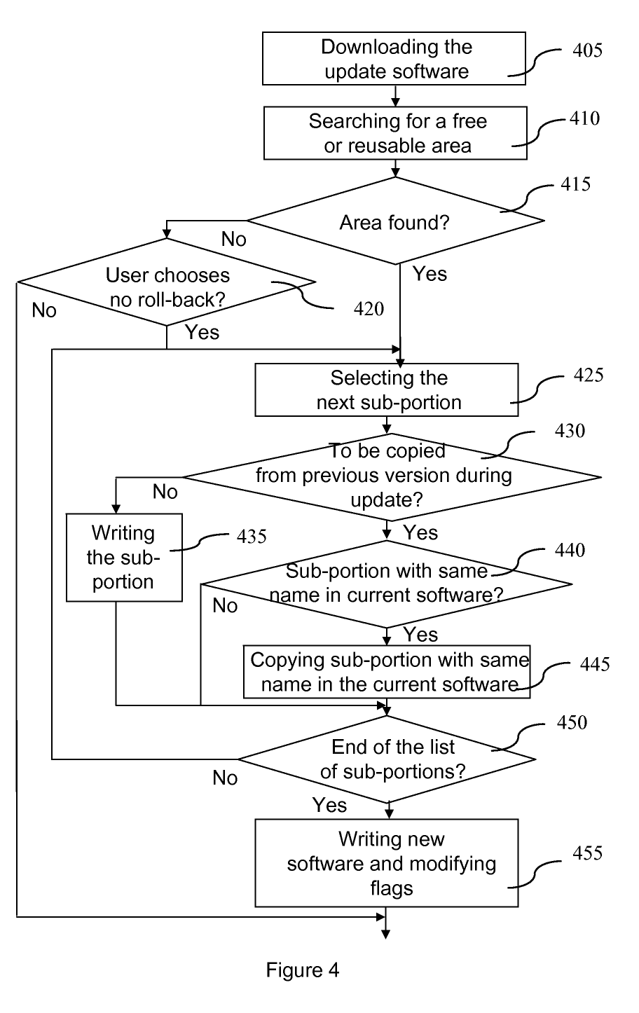

FIG. 4 shows, in the form of a logical diagram, steps utilized during a software update in a particular embodiment of the method that is the subject of the present invention,

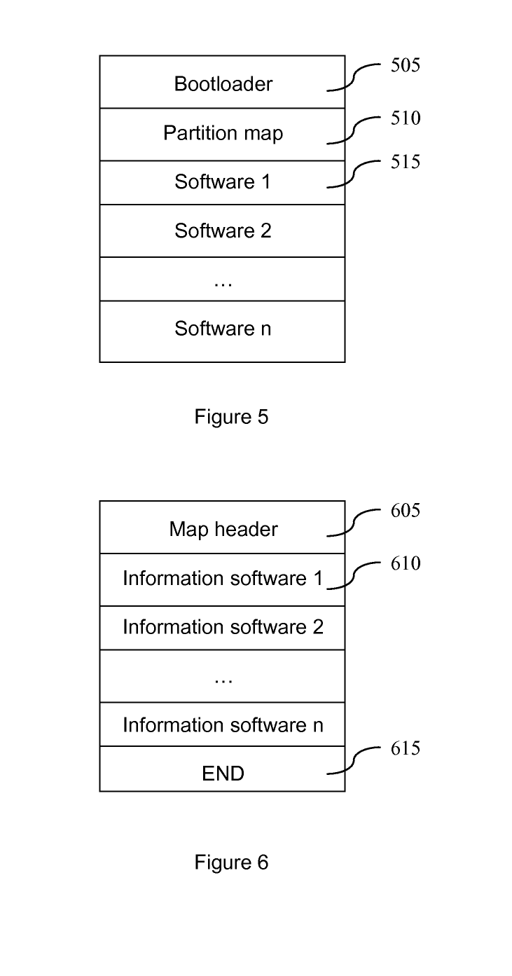

FIG. 5 shows, schematically, a partition organization utilized in particular embodiments of the present invention,

FIG. 6 shows, schematically, a partition map format utilized in particular embodiments of the present invention,

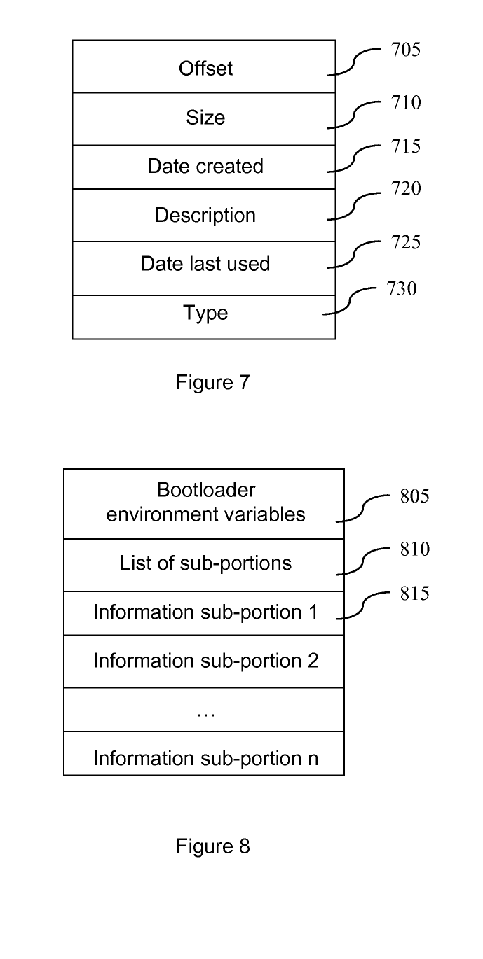

FIG. 7 shows, schematically, information relating to each of a memory's partitions, information utilized in particular embodiments of the present invention,

FIG. 8 shows, schematically, a software format utilized in particular embodiments of the present invention,

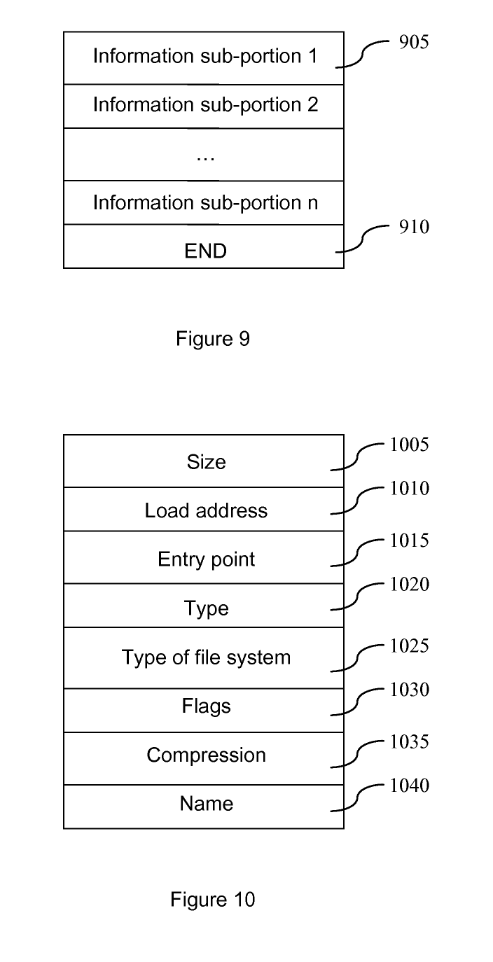

FIG. 9 shows, schematically, a list of information about the sub-portions utilized in particular embodiments of the present invention,

FIG. 10 shows, schematically, information about a sub-portion utilized in particular embodiments of the present invention,

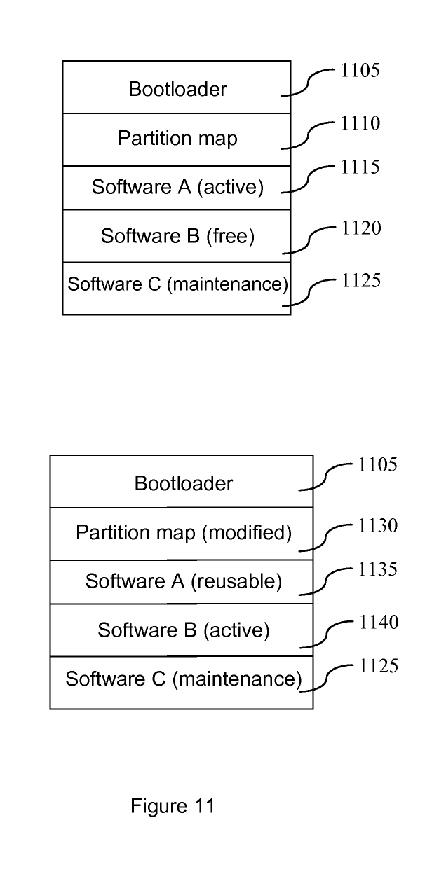

FIG. 11 shows, schematically, an example of partition configurations in non-secured dynamic mode, before and after the update,

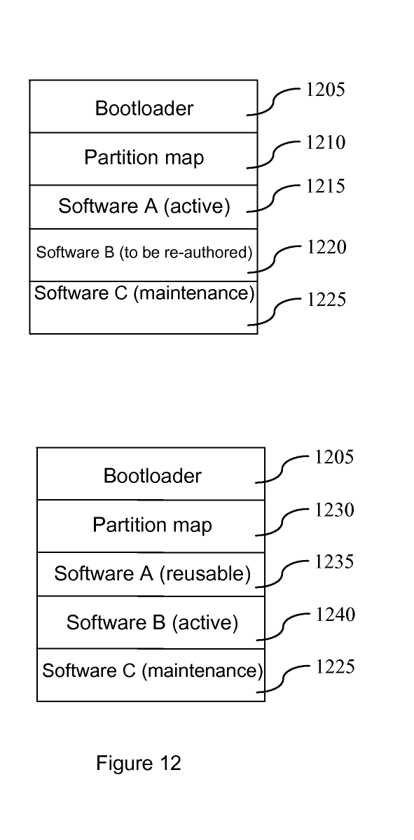

FIG. 12 shows, schematically, an example of partition configurations in secure static mode with re-authoring (re-encoding), before and after the update,

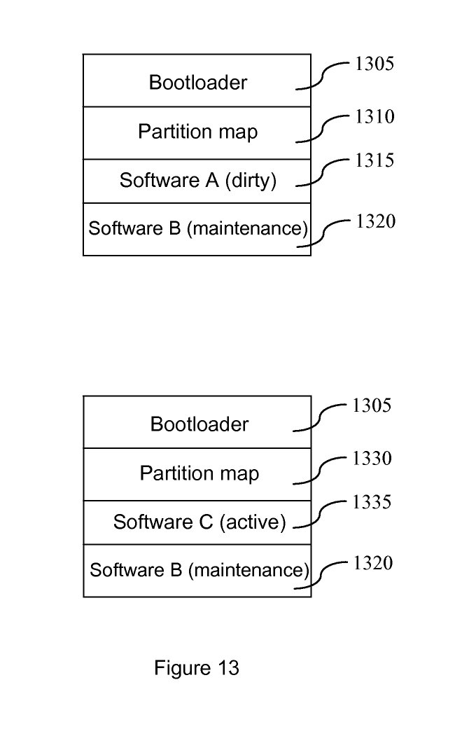

FIG. 13 shows, schematically, an example of partition configurations in recovery mode only, before and after the update, and

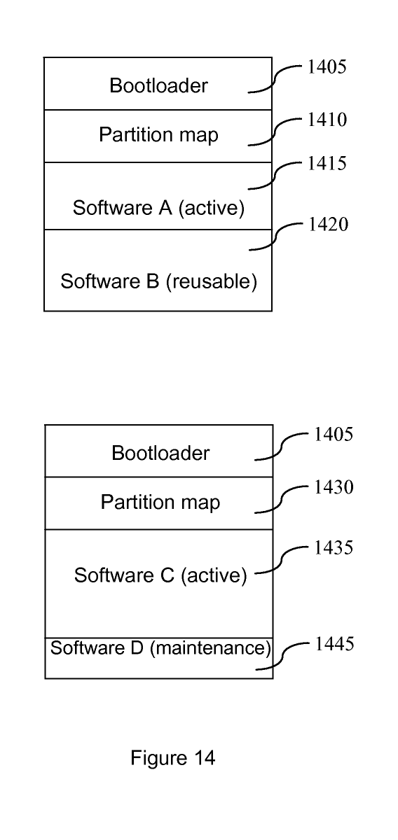

FIG. 14 shows, schematically, an example of partition configurations in dynamic switching mode, before and after the update.

Throughout the description, the terms update and upgrade are used interchangeably to mean replacing one version of a proprietary software program by another.

In the embodiment described and shown with reference to the figures, the secure update involves the different software layers of an embedded system in order to improve its reliability and security and to reduce the risk of making the system unusable during the updating. In this described embodiment, several new features are utilized in order to obtain an update of an embedded system's software that is more flexible, more secure and more reliable, compared to known updates.

To this end, firstly the proprietary software program's storage space is divided into several partitions. Each partition contains a version of the software program.

Secondly, each version of the software program is split into several sub-portions, notably:
bootloader environment variables,
a logo (optional), to be displayed at startup,
an operating system kernel (abbreviated as “kernel”) image,
a root file system image and
one or more optional generic data images.

Finally, a set of flags and parameters is associated to each of these sub-portions enabling the advanced features that are the subjects of the present invention to be supported.

A bootloader is a software program enabling one or more operating systems to be booted (known as “multi-boot”), i.e. it allows several systems to be used at different times on the same machine.

At any time, one single proprietary software program is in operation (it is therefore said to be “active”) while other partitions contain old proprietary software programs, and are therefore reusable, or contain a recovery software program, or have free space that can be used for new proprietary software programs.

When a user decides to update the system, a new proprietary software program is written in an empty or reusable partition and the system in operation is left intact. It is only when the software update has been completed successfully that the partition map is updated so that to the new proprietary software program becomes active and runs in place of the old software program.

If the user does not wish to continue using the updated system, for whatever reason, they may choose to switch back to the previously active proprietary software program or to any other proprietary software program stored in the system.

The partition scheme supports two modes of partition assignment:
a static mode, mainly used for devices requiring highly secure mechanisms and
a dynamic mode, mainly used to give flexibility of use.

The partition schematic can utilize different proprietary software programs with different sizes. The partition schematic is designed so that only the map of assignments—if dynamic mode is used—and one of the proprietary software partitions are modified during the proprietary software update.

The static partition assignment mode makes it possible to retain the assignment distribution status in storage outside the non-volatile memory storing the proprietary software program, for instance in a companion microcontrollers flash memory.

The update and partition schematic supports the encoding and/or the signing and re-authoring of all or part of the software update.

The update and partition schematic supports the retention of all or part of the user settings and/or other partitions of interest between the updates with or without updating formats and without compromising the ability to roll back.

The update and partition schematic can be implemented and used generically, independent of the operating system. The example of an update and partition schematic described below is optimized in combination with UBOOT (registered trademark) as bootloader and the Linux operating system on an ARM9 (registered trademark) architecture processor.

FIG. 1A shows steps for a normal boot of a standard embedded system, from the state of the art, without a recovery or maintenance procedure. During this boot, a step 105 loading the bootloader, a step 110 loading the operating system kernel ('kernel') and a step 115 loading the application are performed.

FIG. 1B shows steps for a boot of an embedded system according to the state of the art supporting a simple maintenance mode. It includes the steps 105 to 115 described with reference to FIG. 1. However, a step 107, during which it is determined whether the boot is being carried out in normal mode, is added between steps 105 and 110. If yes, step 110 follows. Otherwise maintenance mode is engaged, during a step 120.

FIG. 10 shows steps for a boot conforming to a particular embodiment of the method that is the subject of the present invention. During this boot, a step 125 is performed of loading the bootloader, possibly encoded and signed, by the processor.

Then, during a step 130, a partition map is loaded and, if encoded, it is decoded. During a step 135, it is determined whether the boot mode is normal, i.e. that it does not concern either maintenance or a reversion to a previous version.

If the result of step 135 is negative, the maintenance mode described with reference to FIG. 3 is engaged. If the result of step 135 is positive, the standard active proprietary software program is searched for in the partition map during a step 140. During a step 145, it is determined whether this active proprietary software program has been found. Otherwise maintenance mode is engaged. If yes, during a step 150, it is determined whether the previous boot was successful. Otherwise maintenance mode is engaged. If yes, during a step 155, it is determined whether re-authoring needs to be performed.

Otherwise, the proprietary software program is loaded, as illustrated with reference to FIG. 2. If yes, during a step 160, the software program is loaded, re-authoring is performed and the proprietary software program is rewritten after re-encryption and the corresponding flag is cleared.

As illustrated in FIG. 2, to load the proprietary software program the flag for this proprietary software program's successful previous boot is set to “failed” during a step 205. Then, during a step 210, the next sub-portion in the proprietary software program is taken as the current sub-portion, the reiteration of step 210, from step 255, allowing each of the software program's sub-portions to be processed. During a step 215, it is determined whether the current sub-portion must be loaded into RAM depending on the value of the corresponding flag. If not, step 225 follows. If yes, during a step 220, the sub-portion is loaded in RAM and then step 225 follows.

During a step 225, it is determined whether the sub-portion is signed. If not, step 235 follows. If the result of step 225 is positive, during a step 230 it is determined whether the signature is verified. If not, maintenance mode is engaged. If the result of step 230 is positive, step 235 follows, during which it is determined whether the sub-portion is encoded. If not, step 245 follows. If the result of step 235 is positive, during a step 240 an attempt is made to decode the sub-portion and it is determined whether the decoding is successful. If not, maintenance mode is engaged. If yes, during a step 245 it is determined whether the sub-portion is a logo. If not, step 255 follows. If yes, during a step 250 the logo is displayed and step 255 follows during which it is determined whether all the proprietary software program's sub-portions have been processed. If not, step 210 is returned to. If yes, during a step 260 it is determined whether all the required sub-portions have been found. For example, for a system based on Linux, this involves at least one sub-portion with the kernel and one sub-portion with the root file system. If one is in a secure mode, the kernel must be encoded and the root file system must be signed.

If the result of step 260 is negative, maintenance mode is engaged. If the result of step 260 is positive, during a step 265 the proprietary software program is booted. For example, for Linux, the kernel is loaded into RAM and the root file system and other sub-portion list information are passed as parameters. Then, during a step 270 the proprietary software program sets the previous boot flag, for this proprietary software program, to “successful”.

In the maintenance mode illustrated in FIG. 3, during a step 305 the recovery and previous standard proprietary software programs are searched for in the partition map. Then, during a step 310 it is determined whether more than one software program was found during step 305. If not, step 320 follows.

If yes, during a step 315 the list of software programs found is displayed and the user is asked to choose one. Once this choice has been made by the user, step 320 follows, during which it is determined whether the software program must be re-authored, depending on the value of the associated flag. If not, step 330 follows. If yes, during a step 325 the proprietary software program is re-authored and re-written and the associated flag is cleared. Then step 330 follows, during which the proprietary software program is loaded.

FIG. 4 shows the updating of a proprietary software program.

During a step 405, a proprietary update software program is downloaded by a current proprietary software program. During a step 410, a large-enough free or, alternatively, reusable area is sought, in the partition map. During a step 415 it is determined whether such an area has been found. If yes, step 425 follows. If not, during a step 420 a message is displayed asking the user if he/she accepts making it impossible to revert to the current proprietary software program. If the user's response is negative, the process ends. If the user response is positive, the current software program's partition is selected to perform the following steps.

During a step 425, the next sub-portion of the downloaded proprietary software program is considered, this next sub-portion being the first sub-portion in the first iteration of step 425. Then, during a step 430 it is determined whether this sub-portion must be obtained by copying from the previous version during the update, depending on the value of the associated flag. If no, step 435 follows, which consists of writing said sub-portion into non-volatile memory and going to step 450. If yes, during a step 440 it is determined whether a sub-portion has the same name in the current proprietary software program. If not, step 450 follows. If yes, during a step 445 the sub-portion with the same name in the current proprietary software program is copied to form a portion of the updated proprietary software program. Then, during step 450 it is determined whether all images of the updated proprietary software program have been processed. If not, step 425 is returned to. If yes, step 455 follows, where the new proprietary software program is declared active and the old proprietary software program (if any) is declared reusable. Then the process ends.

As FIG. 5 shows, the organization of a memory's partitions utilized by the present invention can take the form of one partition 505 reserved for the bootloader, one partition 510 reserved for a software partition map and a plurality of partitions 515 (only three partitions are shown in FIG. 5) for proprietary software (“firmware”) 1 to n. Partitions 505 and 510 can have a fixed size if this proves necessary or simplifies the implementation. In contrast, partitions 515 are, preferably, of varying sizes according to their content.

As FIG. 6 shows, the format of the map partition 510 can take the form of an optional map header 605 allowing the format's compliance to be checked. After the map header 605, the format of map partition 510 comprises information 610 about each partition represented in the memory, described with reference to FIG. 7. Finally, the format of map partition 510 comprises an end indicator 615 which signifies the end of the list of partitions.

As FIG. 7 shows, the information 610 about each proprietary software program in partition map 510, according to a particular implementation of the present invention, comprises the following fields:
“Offset” 705, which represents the start position of the partition (“Firmware offset”) calculated from the beginning of the non-volatile memory.
“Size” 710, which represents the size of the proprietary software program,
“Creation Date” 715, which represents the date on which the proprietary software program was recorded in the non-volatile memory; preferably this value is “0” in static mode and is not updated,
“Description” 720, which contains, in particular in the typical “proprietary software” case, the version number [e.g. “2.0.1”] and the build number (for example, “20080202213012”),
“Date last used” 725, which is the date the proprietary software program was used last; this value can be used when the proprietary software program's update fails and the system must revert to another proprietary software program; this value is preferably “0” in static mode and is not updated,
“Type” 730, which contains the partition types and the following flags:
“Type”, which can be “free”, “proprietary software” or “reserved”,
“Sub-type”, which, in the case of a “proprietary software” type, can be “standard”, “maintenance”, “development” or “reserved”,
“Flags”, only used in dynamic mode and set to a special value in static mode:
“dirty”, which means that this space is in an unknown condition, possibly as a result of an error during an update and
“reusable”, which means that this space comprises unused data, such as an old proprietary software program, and it can be reused by re-writing, for example for an update.

In the case of a “proprietary software” type:
a “success” flag indicates the success of the boot and
a “status” flag set to one of the following values:
“active” (which means that the proprietary software program is the proprietary software program that is currently active),
“inactive” (which means this is a previously used proprietary software program),
“to be re-encrypted” (which means that, in order to become active, this proprietary software program needs to be re-encrypted) or
“reserved”.

As FIG. 8 shows, the format of proprietary software programs comprises:
bootloader environment variables 805,
a list of information about the sub-portions 810, of varying size, and
the sub-portions 815 (only three sub-portions are shown in FIG. 8).

As FIG. 9 shows, the list of information about the sub-portions comprises information 905 about each sub-portion and an indicator 910 which indicates the end of the list.

As FIG. 10 shows, the information 905 about a sub-portion, according to a particular implementation, comprises the following fields:
“Size” 1005, which represents the size of the sub-portion,
“Load address” 1010 which represents the load address in memory,
“Entry point” 1015, which represents the address of the entry point when the sub-portion is code,
“Type” 1020, which represents the sub-portion type, from the values “Logo”, “kernel”, “root file system”, “generic file system”,
“File system type” 1025, which specifies the format of the file system used for said sub-portion (e.g. “CRAMFS”, “Ext3” or “Yaffs2, registered trademarks),
Flags 1030, which represent:
whether the sub-portion is encoded and/or signed or neither encoded nor signed,
whether the sub-portion must be loaded into RAM (e.g. operating system kernel),
whether the sub-portion of the proprietary software program must be copied for a new proprietary software program at the time of an update. This is useful, for instance, for preserving User Settings when roll-back is allowed. In such cases, a software program sub-portion that must be copied has this flag in the new proprietary software program with the same image name. The update process will therefore search in the old proprietary software program and find the corresponding previous sub-portion and copy it into the current proprietary software program.
“Compression” 1035, which indicates the compression type (e.g. “none”, “gzip”, “Izo”, registered trademarks) and
“Name” 1040, representing the name of the sub-portion.

An implementation example is described below. With respect to the bootloader partition, it contains at least one copy of the bootloader. It is noted that in some systems, because of technical limitations, this bootloader can be subdivided into different phases and sub-partitions. For example, some “Texas Instruments” (registered trademark) integrated circuits start up with a “UBL” of less than 15 kilobytes that, in turn, boots a “UBOOT”. The present invention supports these situations by bringing the different bootloader loading steps together into a single “generic” step, the implementation handling specific aspects of these situations. It is also noted that the bootloader environment variables are stored in the proprietary software partition and not in the bootloader partition, so that the bootloader partition does not need to be changed during a proprietary software program update.

Finally, it is noted that some systems can use multiple bootloader or bootloader portion copies, e.g. to allow updating of the bootloader, to overcome the risk of a damaged block appearing in the bootloader partition so as to overcome the limitations of some systems that do not support such blocks. The preferred implementation uses a bootloader that supports damaged blocks.

The implementation of the bootloader can support either only static mode, for maximum security, or both static and dynamic modes, or only dynamic mode, as described below. It is noted that, for very secure systems, the bootloader is preferably encoded or signed.

The software partition map partition contains the partition map. In the static mode case, the partition map can be recorded only once in the first valid area in the specified partition for this purpose and is never re-written. In the dynamic mode case, the partition map is always written in two consecutive valid areas of the partition allocated to it. In this way, even if one of these areas becomes invalid, for example due to a damaged block when “NAND” memory is used, the partition map is always available and is re-written in another valid area. Because the number of updates is assumed to be limited, it should be sufficient to have a small number of areas, e.g. five, allocated for this purpose within the partition dedicated to the partition map.

The partition map contains information about the partition structure of the proprietary software programs stored in the non-volatile memory and is updated during the proprietary software program update in dynamic mode. In order to obtain a secure mode, in the dynamic mode case the partition map must be re-encoded after modification. Some systems do not support re-encoding utilizing hidden private keys, so as to prevent hackers using these keys to generate encoded proprietary software programs. In this case, either a separate key is utilized, stored in encoded form at the beginning of the partition map or in the bootloader, or static mode is used.

Each of the proprietary software partitions contains a proprietary software program. A proprietary software program contains the bootloader's environment variables, the list of sub-portion headers and one or more sub-portions. A sub-portion can be a logo (optional), a kernel that is mandatory, a root file system, the application or the application parameters.

The system can comprise a maintenance software program, which is never erased, in one of the partitions. This maintenance software program can be useful if a proprietary software update fails and no usable proprietary software program can be found. The maintenance software partition has a particular sub-type and cannot be reused for new versions of the software program but it can optionally be reused during the updating of the maintenance software program.

In secure mode, the bootloader environment variables and the list of information about the sub-portions are preferably encoded. Each sub-portion is encoded or signed if its “encoded/signed” flag indicates this. In the case of a secure system (with medium or high security), the kernel and root file system sub-portions must be signed (if medium security) or encoded (if high security). If this is not the case, the bootloader does not boot the kernel. The other sub-portions can be either signed or unsigned, for example if it concerns user settings.

With respect to the update with roll-back support, the number of full proprietary software programs must be greater than or equal to two.

During the update:
the update tool downloads the new proprietary update software program (for example using one of the HTTP, acronym for “hypertext transfer protocol”, or MTP, acronym for “media transfer protocol”, protocols or local files) and checks the version information and
in dynamic mode, the update tool reads the partition map and obtains the address of a large-enough free or reusable partition. In static mode, the update tool finds an index for a new proprietary software program by taking the next index in the list of partitions. This partition is used to write the new software program.
the update tool searches in the new proprietary software program's sub-portion information list for any sub-portion flagged “to be copied during the update”. If it finds such sub-portions, this tool searches for a sub-portion in the current proprietary software program that has the same name as the sub-portion in question and copies the contents of this sub-portion into the new software program. It is noted that this step is primarily intended for reusing existing user settings.

In secure mode, since the partition map is encoded in static mode, and since decoding is often only available when the system is started up, either a full partition map must be kept in RAM at the time of the boot, which is the preferred embodiment, or a partition description to be used for the update is transferred to the kernel.

In dynamic mode, the update tool updates the partition map by adding information about the new proprietary software program and setting its flag to “active”.

In addition, the previously active proprietary software program's flags are set to “reusable/inactive” and its last use date is updated.

In static mode, the update tool updates the current proprietary software program's index and statuses in the subsystem used for their storage.

Finally, if necessary (e.g. re-encryption required and available only when the system is started up), the update tool starts the system up again or preferably directly boots the new software program.

FIG. 11 shows an example of partition configurations in non-secured dynamic mode, before and after the update. Before the update, the partition configuration comprises the bootloader partition 1105, the partition map partition 1110, the partition of software program A, active, 1115, the partition of software program B, free, 1120 and the (optional) partition of software program C, recovery, 1125. After the update, the partition configuration comprises the bootloader partition 1105, the modified partition map partition 1130, the partition of software program A, now reusable, 1135, the partition of software program B, now active, 1140 and the (optional) partition of software program C, recovery, 1125.

FIG. 12 shows an example of partition configurations in secure static mode with re-authoring, during and after the update. During the update, the partition configuration comprises the bootloader partition 1205, the partition map partition 1210, the partition of software program A, active, 1215, the partition of software program B, to be re-authored, 1220 and the (optional) partition of software program C, recovery, 1225. After the update, the partition configuration comprises the bootloader partition 1205, the partition map partition, unchanged, 1210, the partition of software program A, reusable and not modified, 1235, the partition of software program B, active after re-authoring, 1240 and the (optional) partition of software program C, recovery, 1225.

If the non-volatile memory is limited, e.g. for cost reasons, and it is not possible to store at least two full versions of the software program to allow roll-back then only one complete software program and a maintenance software program, reduced and handling the critical cases, are stored, the new version of the software program simply replacing the current version. This mode of utilizing the present invention is called “maintenance only”.

FIG. 13 shows an example of partition configurations in recovery mode only, during and after the update. During the update, the partition configuration comprises the bootloader partition 1305, the partition map partition 1310, the partition of software program A being written (dirty), 1315, and the partition of software program B, maintenance, 1320. After the update, the partition configuration comprises the bootloader partition 1305, the partition map partition 1310, the partition of software program C, active, 1335, and the partition of software program B, maintenance, 1320. In the case of dynamic switching allowing roll-back by restoring a previous version, even if the system has been designed to support roll-back, by providing enough non-volatile memory, subsequent updates can have an increasing size and exceed the size limit at which two versions can be preserved. In such cases, the user is informed of this constraint during the update process and has the option of either not updating or of losing the ability to roll-back. If the user chooses to continue with the update, the update process merges and recreates the existing partitions in order to:
create a large partition for the complete new proprietary software program and
update, if necessary, or create, if it does not already exist, the partition for the maintenance software program.

FIG. 14 shows an example of partition configurations in dynamic switching mode, from roll-back before and in ‘maintenance only’ mode after, before and after the update. Before the update, the partition configuration comprises the bootloader partition 1405, the partition map partition 1410, the partition of software program A, active, 1415, and the partition of software program B, reusable, 1420. After the update, the partition configuration comprises the bootloader partition 1405, the modified partition map partition, 1430, the partition of software program C, active and modified, 1435, and the partition of software program D, maintenance, modified, 1445.

With respect to update management, the version check is performed on the server side. The client sends its current version number with other information, such as the device identifier, to the server using the HTTP “GET” request. For example, this request takes the form GET “http://maintenance.awox.com/fcheck?version=XXXX&device=YYYY”.

The server returns the response “204 No Content” if no update is available for the software program. If an updated version is available, the server returns the response “200 OK” and, in the response body, a description of the update (version, size and new features). A free text format, an XML (acronym for “extensible markup language”) format or a “.ini” syntax can be used for this, depending on the tool available for using this response. A language can also be specified in the request, using an “Accept-Language” header, so that the server returns a description in this language.

The server finds the appropriate version that could update the current version, a version that cannot be the latest version, as explained below. This procedure is also helpful if the update is not free of charge. In such a case, the server returns information indicating that the updated software program can only be downloaded after payment. The user can contact the seller to make this payment. After downloading, a local update method, such as USB (acronym for “Universal Serial Bus”), as explained below, can be used for the update.

It is noted that the version check is not obligatory for the local update, e.g. via a USB/MMC-SD (acronym for “USB/Multimedia Card—Secure Digital”). This is useful in the case of an update by downgrading, for example for a demonstration or trial version.

In the case where the non-volatile memory is damaged, and the user presses a forced update button, the client is not always able to send information indicating the current version to the server. In this case, only the device identifier is sent to the server. Based on this identification, the server returns the last available free version of the software program for the device model identified.

The user accesses, for example, the “settings” menu and then “update” to determine whether an update is available. In a variant, a search for the availability of an update is performed periodically and the user is alerted by a warning if an update is available.

For the proprietary software program acquisition method, a network, for example utilizing the HTTP protocol, or a local memory, for example a USB connector type, can be used. In the first case, the file for the proprietary update software program can be downloaded by using the HTTP “GET” command, for example:

“GET http://maintenance.awox.com/fget?version=XXXXX&device=YYYY”

If the request is valid, the server returns the update file. Otherwise, the server returns an error message, e.g. “404 file not found”.

In the case where a local memory is used, the user's GUI provides a simple method of browsing and selecting a local update file.

With respect to manual switching to maintenance mode, the bootloader is able, on startup, to detect a keystroke combination or a specific infrared code if the product has a remote control. This is in order to interrupt the normal startup and display a dialog box of alternatives. The dialog is, for instance, as follows:

“You have selected maintenance mode. Do you want to restore your system? Press 9 to start maintenance mode, press 1 to start the system with the current version v1.2.6, press 2 to start the system with the previous version v1.2.5, installed Jan. 25, 2007 and used for the last time Jul. 21, 2007.”

This option is particularly useful if the main system is damaged and the normal startup does not work. This method can also be used as an installation instruction when the user has received a paid software program and stored it on a local medium, such as a USB key. During the boot, the user can select to boot the device in maintenance mode and browse to select this local file.

The bootloader sets the successful boot flag of the proprietary software program that is being booted to “failed”. The software program sets this flag to “successful” at the end of the boot sequence. The bootloader checks this flag when it searches for a proprietary software program to be booted and if this flag does not indicate a success, the loader displays a dialog box, as described above, and by default proposes the last version of the proprietary software program used that was booted successfully. The behavior of the bootloader thus depends on the choices available.

With respect to the partition for the device's parameter values, notably the user settings, for the vast majority of products, a dedicated file system is used to store them, for instance the WiFi connection settings and MAC (acronym for “media access control”) address, the user's language, etc. This file system is stored as a sub-portion of the software program to allow the parameter values to be saved.

To allow the user to keep his/her personal parameter values during an update, this sub-portion of the software program uses the “to be copied during the update” flag in the information. If this flag indicates that a copy is to be made, the update tool searches in the active proprietary software program for an image with the same name and copies its contents into the new proprietary software program in non-volatile memory.

It is noted that, in embodiments, the information needed for re-authoring is stored outside the non-volatile memory holding the proprietary software program, such as a companion microcontrollers flash memory.

1-16. (canceled)

17. A method for updating computer applications, that comprises:
a step of creating partitions for software programs in a non-volatile memory,
a step of writing, in a first partition, an initial version of a software program, bootloader environment variables of said initial version of the software program, and at least one sub-portion of the operating system kernel and
during the updating of said software program, a step of writing in a second partition, different from the first partition, a new version of the software program different from the current version, bootloader environment variables of said new version of the software program, and at least one sub-portion of the operating system kernel.

18. The method according to claim 17, wherein during the partition creation step, a map of software partition assignments is also created listing the versions and status of the software program present and indicating which version of the software program is active.

19. The method according to claim 17, wherein in at least one step of writing to a partition, a list of sub-portions of a version of the software program including a kernel and root file system is written in addition to bootloader environment variables.

20. The method according to claim 17 that comprises a step of determining whether the new version of the software program is in operation and, if so, a step of assigning to the new version an indicator that it is active, and assigning to the previous version an indicator that it is inactive.

21. The method according to claim 20, wherein said indicators are stored in a software partition map.

22. The method according to claim 21, wherein at least one part of the software partition map is stored outside the non-volatile memory storing the proprietary software program, e.g. in a separate non-volatile memory.

23. The method according to claim 17, wherein during the updating of the software program it is determined whether this version of the software program must be re-encrypted and, if so, re-encryption is performed and the version is rewritten in the corresponding partition.

24. The method according to claim 23, wherein the information needed for re-authoring is stored outside the non-volatile memory holding the proprietary software program, such as a companion microcontroller's flash memory.

25. The method according to claim 17, wherein during the update, a large-enough free or reusable area is sought in the partitions and, if at least one is found, the step of writing the new version of the software program different from the current version is performed.

26. The method according to claim 25, wherein if a large-enough free or reusable area is not found, a step is performed of requesting the user to choose whether to accept not being able to roll back to the current version of the software program after the update and if the user agrees, in an area covering the first partition, the step is performed of writing the new version of the software program different from the current version.

27. The method according to claim 25, wherein if a large-enough free or reusable area is not found, but the combination of several areas is sufficient, a step is performed of requesting the user to choose whether to accept not being able to roll back to the current version of the software program after the update and if the user agrees, in an area covering several partitions, the step is performed of writing the new version of the software program different from the current version, and the partition map is modified.

28. The method according to claim 27, wherein in addition to writing the new version of the software program, an additional partition is also created and a minimal version of the software program is written there, used exclusively for maintenance and/or recovery purposes.

29. The method according to claim 17, wherein during the updating of the software program it is determined, for each sub-portion of the update software program, whether this sub-portion must be copied from the previous version of said software program and, if so, the corresponding sub-portion is copied from the old version's partition to the new version's partition.

30. A device for updating computer applications, that comprises:
a means of creating partitions for software programs in a non-volatile memory and
a means of writing designed to write, in a first partition, an initial version of a software program, bootloader environment variables of said initial version of the software program, and at least one operating system kernel sub-portion and, during the updating of said software program, to write in a second partition, different from the first partition, a new version of the software program different from the current version, bootloader environment variables of said new version of the software program, and at least one operating system kernel sub-portion.

31. The device according to claim 30, wherein the means of creating partitions is adapted to further create a map of software partition assignments listing the versions and status of the software program present and indicating which version of the software program is active.

32. The device according to claim 30, wherein the means of writing to a partition is adapted to write a list of sub-portions of a version of the software program including a kernel and root file system is written in addition to bootloader environment variables.

33. The device according to claim 30 that further comprises a means of determining whether the new version of the software program is in operation and a means of assigning adapted, if so, to assign to the new version an indicator that it is active, and to the previous version an indicator that it is inactive.

34. The device according to claim 33, wherein the means of assigning is adapted to store said indicators in a software partition map.

35. A computer program that can be loaded into a computer system, said program containing instructions allowing the utilization of the method according to claim 17.

36. A data carrier that can be read by a computer or microprocessor, removable or not, holding the instructions of a computer program, characterized in that it allows the utilization of the method according to claim 17.
